(19) United States
(12) Patent Application Publication
(10) Pub. No.: US 2026/0316883 A1
(43) Pub. Date: Oct. 15, 2026

(54) Method for Controlling a Drive Device for a Bicycle, and Control Device for Carrying out the Method

(71) Applicant: ZF Friedrichshafen AG, Friedrichshafen (DE)

(72) Inventors: Alexander Jungaberle, Schlier (DE); Uwe Schraff, Markdorf (DE); Markus Wallner, Friedrichshafen (DE)

(21) Appl. No.: 19/117,192

(22) PCT Filed: Sep. 29, 2022
(86) PCT No.: PCT/EP2022/077089

§ 371 Date: Mar. 31, 2025

(51) Int. Cl. B62M 6/50

(52) U.S. Cl. CPC B62M 6/50

(57) ABSTRACT

A method for the open-loop control of a propulsion device (1) of a bicycle (3) is provided. The bicycle (3) is at least intermittently operated with muscle power using a pedal device, and the propulsion device (1) has at least one electric machine (4) for assisting the operation of the pedal device (2) by muscle power. The method includes: (S1) determining inclination information regarding the bicycle (3), which relates to an inclination angle of the roadway in a direction of travel of the bicycle (3); (S2) deriving a propulsion request for the bicycle (3) at least from an operation of the pedal device (2); and (S3) controlling the electric machine (4) in an open loop with regard for the inclination information and the propulsion request such that a downhill force acting in the longitudinal direction of the bicycle (3) is at least partially compensated for.

### CROSS-REFERENCE TO RELATED APPLICATION

The present application is related and has right of priority to PCT Application No.

PCT/EP 2022/077089 filed on Sep. 29, 2022, which is incorporated by reference in its entirety for all purposes.

### TECHNICAL FIELD

The present invention relates generally to a method for the open-loop control of a propulsion device of a bicycle, which is at least intermittently operated with muscle power using a pedal device. In particular, the present invention relates generally to a method for adjusting a propulsive force of a propulsion device for a bicycle, which is in the form of a pedelec or an e-bike, wherein a dynamic mode of operation can also be achieved in different situations.

### BACKGROUND

Bicycles having an additional electrical propulsion unit for assisting the muscle power are known. Such bicycles which are in the form of pedelecs or e-bikes are also used in hilly regions having uphill gradients and downhill gradients, since the limitation of the muscle power, in particular when riding uphill, can be largely eliminated by the assistance provided by an electric machine provided in the propulsion device.

### BRIEF SUMMARY

Example aspects of the invention provide a method for the open-loop control of a propulsion device of a bicycle, which is at least intermittently operated with muscle power using a pedal device, wherein the propulsion device has at least one electric machine for assisting an operation of the pedal device using muscle power. The method has the following steps: determining inclination information regarding the bicycle, which relates to an inclination angle of the roadway in a direction of travel of the bicycle; deriving a propulsion request for the bicycle at least on the basis of an operation of the pedal device; and controlling the electric machine in an open loop with regard to the inclination information and the propulsion request, so that a downhill force acting in the longitudinal direction of the bicycle is at least partially compensated for at least during a dynamic mode of operation of the bicycle.

When determining the inclination information regarding the bicycle, the inclination angle of the bicycle in a longitudinal direction of the bicycle can be directly determined, estimated, or detected. The longitudinal direction of the bicycle is aligned with the direction in which the bicycle typically travels forward. It is also possible to determine inclination information regarding the bicycle as a relative piece of information, on the basis of which it can be made possible to assess whether the inclination angle of the roadway is large or small.

When the propulsion request for the bicycle is derived, which propulsion request results at least from an operation of the pedal device, an input by the bicycle rider can also be taken into account. In the open-loop control of the electric machine with regard to the inclination information and the propulsion request, an output torque and, additionally or alternatively, a rotational speed of the electric machine can be controlled in an open loop. Alternatively, an electrical input power of the electric machine can be controlled in an open loop, which electrical input power is relative to the output power of the electric machine.

In the open-loop control of the electric machine with regard for the inclination information and the propulsion requests, such that a downhill force acting in the longitudinal direction of the bicycle is at least partially compensated for at least during a dynamic mode of operation of the bicycle, uphill travel and downhill travel of the bicycle are both taken into account. The downhill force in the longitudinal direction of the bicycle can act at the front when the bicycle is on a downhill gradient. Furthermore, the downhill force in the longitudinal direction of the bicycle can act at the rear when the bicycle is on an uphill gradient. If the inclination information defines that the bicycle is located on level terrain without being acted upon by a significant downhill force, then, according to example aspects of the invention, this is not to be compensated for. The downhill force acting during uphill travel therefore acts counter to the direction of travel, whereas the downhill force acting during downhill travel acts in the direction of travel of the bicycle.

According to one example embodiment, in the step for determining inclination information regarding the bicycle, a signal from at least one inclination sensor provided on the bicycle can be taken into account. The inclination sensor can be mounted such that the inclination of the bicycle and, in particular, the inclination angle of the roadway can be detected. It is assumed that the wheels of the bicycle are located on the roadway. The inclination sensor can be fixedly mounted on the bicycle, so that an inclination of the bicycle directly results in a signal at the inclination sensor. The position of the inclination sensor on the bicycle is not limited, provided the function for determining the inclination of the bicycle is detectable.

According to one example embodiment, the signal from the at least one inclination sensor provided on the bicycle can be a signal from a gyro sensor. Gyro sensors are suitable for determining an inclination relative to the horizontal. Gyro sensors also output a quantitative signal, which yields the inclination angle of the bicycle relative to the horizontal.

According to one example embodiment, in the step for determining inclination information regarding the bicycle, a signal from a GPS system for determining the global position of the bicycle can be taken into account. A GPS system is capable of determining the position with relatively great accuracy. The GPS system can be mounted on the bicycle. Therefore, the GPS system can determine the position of the bicycle and, using the position, determine the inclination information which relates to the inclination angle of the roadway. For this purpose, the inclination information can be directly determined from the GPS system. Alternatively or additionally, the inclination information can be ascertained from a database in response to a position query and determined at least by estimation.

According to one example embodiment, in the step of determining inclination information regarding the bicycle, an acceleration in the longitudinal direction, in particular in the direction of travel of the bicycle, and at least one piece of information related to the present propulsive force of the bicycle can be taken into account to determine inclination information as an estimated inclination angle. In this example embodiment, a force balance can be carried out in order to be able to infer an inclination angle of the roadway on which the bicycle is located. The entirety of the propulsive force acting on the bicycle can be taken into account. Furthermore, an acceleration can be taken into account, which acceleration results from the propulsive force acting on the bicycle when the bicycle is located on level terrain. Therefore, in this example embodiment, the inclination angle can be inferred from a deviation from the acceleration that results at a predefined propulsive force of the level terrain.

According to one example embodiment, in the step of deriving a propulsion request for the bicycle, at least one cadence during an operation of the pedal device can be taken into account. The cadence is a rotational speed of the pedal device that is predefined by the bicycle rider. The cadence can be directly or indirectly detected by a sensor. At a high cadence, in particular at a high rotational speed of the pedal device, which is predefined by the rider, it can be assumed that the rider desires a dynamic propulsion of the bicycle. By comparison, at a very low cadence, it can be assumed that the dynamic requests on the operation of the bicycle are rather low.

According to one example embodiment, in the step of deriving a propulsion request for the bicycle, at least one torque during an operation of the pedal device can be taken into account. In this example embodiment, a means for detecting a torque can be provided, which torque is provided via the pedal device for the propulsion device. This means can be, in particular, a torque sensor, which is linked to the pedal device. When there is a high torque during operation of the pedal device, it can be assumed that the rider desires a dynamic mode of operation of the propulsion device. By comparison, when there is a very low torque during operation of the pedal device, it can be assumed that the dynamic requests on the operation of the bicycle are low.

According to one example embodiment, in the step of controlling the electric machine in an open loop with regard for the inclination information and the propulsion request, the propulsive force of the electric machine for assisting the propulsion by the pedal device can be controlled in an open loop on the basis of a basic characteristic diagram when it is determined that the bicycle is on a roadway without an uphill gradient or with only a slight uphill gradient, wherein the propulsive force of the electric machine is controlled in an open loop for assisting the propulsion by the pedal device on the basis of a gradient characteristic diagram when it is determined that the bicycle is on a roadway having an uphill gradient, wherein, on the basis of a propulsion request, the propulsive force of the electric machine during open-loop control with the gradient characteristic diagram is greater than during open-loop control with the basic characteristic diagram. The basic characteristic diagram is used when there is no uphill gradient or only a negligible uphill gradient. The gradient characteristic diagram is used when it is determined that an uphill gradient is present. On the basis of the basic characteristic diagram and on the basis of the gradient characteristic diagram, information can be derived which can be used for the open-loop control of the propulsive force of the electric machine. The input variable for the basic characteristic diagram and for the gradient characteristic diagram is at least information regarding the propulsion request for the bicycle and the inclination information regarding the bicycle. In one example embodiment, for a predefined propulsive force request, the propulsive force resulting from the gradient characteristic diagram is greater by a predetermined factor than the propulsive force resulting from the basic characteristic diagram, wherein the factor has a predetermined correlation to the inclination angle of the roadway. In particular, the factor is that much greater, the greater is the inclination angle of the roadway on an uphill gradient.

According to one example embodiment, the propulsive force of the electric machine can be controlled in an open loop with regard for an optionally variable gear ratio between the electric machine, or the pedal device, and a driving wheel of the bicycle. In this example embodiment, the fact that the propulsive force output by the electric machine is optionally transmitted via a transmission device with a gear ratio onto the driving wheel is taken into account, wherein the gear ratio is optionally variable. In particular, in a propulsion device, a continuously variable or a stepped transmission can be provided between the electric machine and the driving wheel of the bicycle. Furthermore, a continuously variable or stepped transmission device can also be provided between the pedal device and the driving wheel. Since the propulsive force acting on the driving wheel is decisive for example aspects of the present substantive matter, according to this example embodiment, the present gear ratio between the electric machine, or the pedal device, and the driving wheel of the bicycle can be quantitatively taken into account.

The propulsive force can be increased according to the example aspects of the present invention if an uphill gradient is detected, so that a downhill force acting in the longitudinal direction of the bicycle, specifically counter to the direction of travel of the bicycle, can be at least partially compensated for at least during a dynamic mode of operation of the bicycle. The concept is not limited to the open-loop control of the propulsive force on an uphill gradient, however. This is the case because, according to example aspects of the invention, the propulsive force can be reduced if a downhill gradient is detected, so that a downhill force acting in the longitudinal direction of the bicycle, specifically in the direction of travel of the bicycle, can be at least partially compensated for at least during a dynamic mode of operation of the bicycle.

According to another example aspect, a control device of a propulsion device of a bicycle which is at least intermittently operated with muscle power using a pedal device is provided, wherein the propulsion device has at least one electric machine for assisting an operation of the pedal device by muscle power, wherein the control device has input interfaces for receiving signals and output interfaces for outputting signals, and a device for the open-loop control of a propulsive force of the at least one electric machine, wherein the control device is designed to carry out the method having one or more of the above-described features.

### BRIEF DESCRIPTION OF THE FIGURES

FIG. 1 shows a schematic view of a bicycle on which the example embodiments of the method are applicable;

FIG. 2 shows a bicycle on a roadway in a schematic view for illustrating the example embodiments; and

FIG. 3 shows a schematic view of steps of the method.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

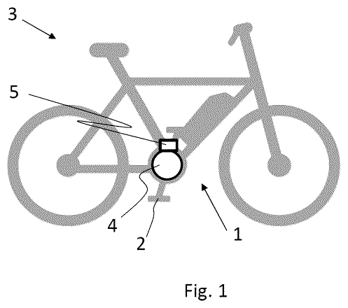

Initially, a bicycle 3 is described with reference to FIG. 1, on which bicycle the method according to example aspects of the invention is applicable. The bicycle 3 shown in FIG. 1 has a steerable front wheel and a non-steerable rear wheel. The front wheel and the rear wheel are attached to a frame. Between the front wheel and the rear wheel, the bicycle 3 has a propulsion device 1. The propulsion device 1 is provided in the region of the bicycle 3 at which a bottom bracket is conventionally located. The propulsion device 1 has an electric machine 4. Furthermore, the propulsion device 1 has a pedal device 2 with which the rider can introduce muscle power into the propulsion device 1 via pedals.

Various elements are provided in the propulsion device 1, which are intended to combine the propulsive force introduced from the pedal device 2 and the propulsive force provided by the electric machine 4. The propulsive force output from the propulsion device 1 is transmitted onto the rear wheel of the bicycle 3 via a traction mechanism (not shown), which is a chain drive in the present example embodiment.

The bicycle 3 has additional further elements which are used to operate the propulsion device 1, such as an electrical energy store device in the form of a rechargeable battery, a brake unit, a control device, and the like.

An inclination sensor 5 is mounted on the bicycle 3 in the present example embodiment.

The inclination sensor 5 is in the form of a gyro sensor in the present example embodiment and is capable of determining the inclination of the bicycle 3 along the longitudinal direction, or in the direction of travel. In particular, the inclination sensor 5 is capable of determining the inclination angle of the roadway on an uphill gradient or on a downhill gradient and transmitting this to the control device.

The control device (not shown in FIG. 1) has input interfaces and output interfaces, which are connected to corresponding elements of the bicycle 3 for communication.

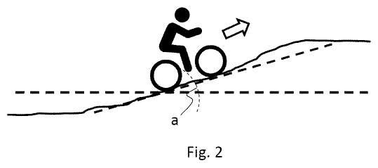

The starting point for example aspects of the present inventive concept is described in the following with reference to FIG. 2. When the bicycle 3 travels on a level roadway which has an inclination angle of approximately zero (0), the entirety of the propulsive force output by the propulsion device 1 is used to compensate for friction, mainly air friction, and, if applicable, for accelerating the system consisting of the bicycle and the rider.

On an uphill gradient having an inclination angle a, as shown in FIG. 2, in addition to the acceleration of the system consisting of the bicycle and the rider and for compensating for frictional losses, the propulsive force is used for the increasing potential energy of the system consisting of the bicycle and the rider. When, in this situation, the rider generates a propulsion request to accelerate the bicycle 3, which is in the form of an increased rotational speed of the crank axle, the resultant acceleration on the uphill gradient having the inclination angle a (greater than zero (0) degrees), as shown in FIG. 2, would be lower than on the level terrain having an inclination angle of zero (0) degrees. Example aspects of the present invention takes this substantive matter into account by determining inclination information regarding the bicycle 3 in the method, which inclination information relates to an inclination angle of the roadway in a direction of travel of the bicycle.

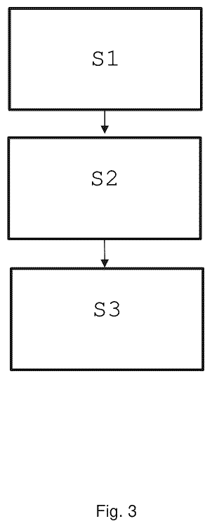

The sequence of the method is briefly explained in the following with reference to FIG. 3.

The method shown in FIG. 3 is continuously carried out and has the starting point in a step S1. In step S1, inclination information regarding the bicycle is determined, which inclination information relates to an inclination angle of the roadway in a direction of travel of the bicycle. In the present example embodiment, the inclination sensor 5, which is shown in FIG. 1, is queried. The query of the inclination sensor 5 yields the inclination angle a of the roadway on which the bicycle is presently located. Furthermore, a propulsion request for the bicycle is derived at least from an operation of the pedal device in a step S2. For this purpose, the rotational speed of the pedal device 3 is queried in the present example embodiment.

In the step S3, the electric machine is controlled in an open loop with regard for the inclination information, in particular the inclination angle a, and the propulsion request, in particular the rotational speed of the pedal device. As shown in FIG. 2, the propulsive force of the electric machine 4 is controlled in an open loop on an uphill gradient such that this propulsive force is greater than for the case in which the bicycle 3 moves on level terrain, so that an acceleration request which is detected in step S2 results in a dynamic acceleration behavior of the bicycle 3, which is comparable to the acceleration behavior on the level terrain on which the inclination angle of the roadway is zero degrees (0°).

In another example embodiment, instead of the inclination sensor 5, a force balance is carried out in the method in order to be able to infer whether the bicycle 3 is on a roadway having an inclination angle a which is greater than zero (0) degrees. For this purpose, the acceleration behavior of the bicycle at a predefined propulsive force on level terrain, i.e., at an inclination angle of zero (0) degrees, and on the uphill gradient, is compared in each case with the inclination angle a to be determined. On the basis of the acceleration behavior, the inclination angle a can therefore be at least approximately inferred, since the acceleration of the bicycle 3 on an uphill gradient having an inclination angle a at a predefined propulsive force is lower than on level terrain. On the basis of the approximated inclination angle a, the method can be carried out in the present example embodiment in a similar way as described above with regard for the output signal of the inclination sensor 5. The above-described example embodiments relate to increasing the propulsive force of the electric machine when an uphill gradient is detected on the basis of a propulsive force which is predefined on level terrain. The invention is not limited thereto. In one example embodiment, the propulsive force of the electric machine can also be reduced when a downhill gradient is detected on the basis of a propulsive force which is predefined on level terrain.

In one example embodiment, a transmission having a variable gear ratio is provided between the pedal device 2 and the driving wheel of the bicycle 3. If the electric machine 4 is coupled to the pedal device 2, the variable gear ratio also acts on the force transmission path between the electric machine 4 and the driving wheel. According to one example embodiment, signals regarding the present gear ratio are supplied to the control device. In this example embodiment, the control device controls the propulsive force in an open loop according to the above-described concept while also taking into account the present gear ratio in the force transmission path between the electric machine 4 and the driving wheel of the bicycle 3.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### Reference Characters

1 propulsion device
2 pedal device
3 bicycle
4 electric machine
5 inclination sensor
a inclination angle
S1 determining inclination information regarding the bicycle
S2 deriving a propulsion request
S3 open-loop control of the electric machine

1-10. (canceled)

11. A method for the open-loop control of a propulsion device (1) of a bicycle (3) that is at least intermittently operated with muscle power using a pedal device, the propulsion device (1) includes at least one electric machine (4) for assisting operation of the pedal device (2) by muscle power, the method comprising:
determining inclination information regarding the bicycle (3), the inclination information descriptive of an inclination angle (a) of a roadway in a direction of travel of the bicycle (3);
deriving a propulsion request for the bicycle (3) based at least part on an operation of the pedal device (2); and
controlling the electric machine (4) in an open loop based on the inclination information and the propulsion request such that a downhill force acting in a longitudinal direction of the bicycle is at least partially compensated for at least during a dynamic mode of operation of the bicycle (3).

12. The method of claim 11, wherein determining of the inclination information regarding the bicycle (3) comprises determining of the inclination information regarding the bicycle (3) based at least in part on a signal from at least one inclination sensor (5) on the bicycle (3).

13. The method of claim 12, wherein the signal from the at least one inclination sensor (5) on the bicycle (3) is from a gyro sensor.

14. The method of claim 11, wherein determining the inclination information regarding the bicycle (3) comprises determining the inclination information regarding the bicycle (3) based at least in part on a signal from a GPS system for determining the position of the bicycle (3).

15. The method of claim 11, wherein determining the inclination information regarding the bicycle (3) comprises determining the inclination information regarding the bicycle (3) based at least in part on an acceleration in the direction of travel of the bicycle and at least one piece of information related to a current propulsive force of the bicycle (3) in order to determine the inclination information as an estimated inclination angle (a).

16. The method of claim 11, wherein deriving the propulsion request for the bicycle (3) comprises deriving the propulsion request for the bicycle (3) based at least in part on at least one cadence during operation of the pedal device (2).

17. The method of claim 11, wherein deriving the propulsion request for the bicycle (3) comprises deriving the propulsion request for the bicycle (3) based at least in part on at least one torque during operation of the pedal device (2).

18. The method of claim 11, wherein:
controlling the electric machine (4) in the open loop comprises controlling a propulsive force of the electric machine (4) for assisting the propulsion by the pedal device (2) in an open loop based on a basic characteristic diagram when the bicycle (3) is located on a roadway without an uphill gradient or with only a slight uphill gradient; and
controlling the electric machine (4) in the open loop comprises controlling the propulsive force of the electric machine (4) for assisting the propulsion by the pedal device (2) in the open loop based a gradient characteristic diagram when the bicycle (3) is located on a roadway having an uphill gradient, wherein, based on the propulsion request, the propulsive force of the electric machine (4) controlled in the open loop with the gradient characteristic diagram is greater than when controlled in the open loop with the basic characteristic diagram.

19. The method of claim 11, wherein controlling the electric machine (4) in the open loop comprises controlling a propulsive force of the electric machine (4) in the open loop based on a selectively variable gear ratio between the electric machine

(4) or the pedal device (2), and a driving wheel of the bicycle (3).

20. A control device of a propulsion device (1) of a bicycle (3) that is at least intermittently operated with muscle power using a pedal device (2), the propulsion device (1) including at least one electric machine (4) for assisting an operation of the pedal device (2) by muscle power, the control device comprising:
input interfaces for receiving signals;
output interfaces for outputting signals; and
a device for the open-loop control of a propulsive force of the at least one electric machine (4),
wherein the control device is configured to implement the method of claim 11.
